(19) United States
(12) Patent Application Publication
(10) Pub. No.: US 2025/0299273 A1
(43) Pub. Date: Sep. 25, 2025

(54) PRODUCT MANAGEMENT DEVICE, PRODUCT MANAGEMENT METHOD, AND RECORDING MEDIUM

(71) Applicant: NEC Corporation, Tokyo (JP)

(72) Inventor: Satoshi KOBATAKE, Tokyo (JP)

(73) Assignee: NEC Corporation, Tokyo (JP)

(21) Appl. No.: 18/915,956

(22) Filed: Oct. 15, 2024

(30) Foreign Application Priority Data
Mar. 25, 2024 (JP) 2024-047501

(51) Int. Cl. G06Q 50/12; G06Q 10/0631; G06Q 10/087

(52) U.S. Cl. CPC G06Q 50/12; G06Q 10/06315; G06Q 10/087

(57) ABSTRACT

A product management device includes an acquisition means for acquiring a discard time of a product based on a photographed image obtained by photographing the product displayed on a furniture and an expiration date of the product; a prediction means for predicting a sales quantity for each time zone based on a prediction model created using past sales quantity information of the product; an estimation means for estimating a number of products to be cooked for each time zone based on the discard time and the sales quantity of the product; and an output means for outputting the number of products to be cooked.

This application is based upon and claims the benefit of priority from Japanese Patent Application No. 2024-047501, filed on Mar. 25, 2024, the disclosure of which is incorporated herein in its entirety by reference.

### TECHNICAL FIELD

The present disclosure relates to a product management device, a product management method, and a recording medium.

### BACKGROUND ART

There is a technique of managing an expiration date and a best-before date of a hot snack product such as fried food sold in a store such as a convenience store. For example, Patent Literature 1 discloses a technique for determining a withdrawal deadline of a fried food from a display shelf based on a state of a parameter related to the expiration date.

### SUMMARY

An object of the present disclosure is to provide a product management device that can easily grasp the number of products to be cooked in a store.

A product management device according to one aspect of the present disclosure includes an acquisition means for acquiring a discard time of a product based on a photographed image obtained by photographing the product displayed on a furniture and an expiration date of the product; a prediction means for predicting a sales quantity for each time zone based on a prediction model created using past sales quantity information of the product; an estimation means for estimating a number of products to be cooked for each time zone based on the discard time and the sales quantity of the product; and an output means for outputting the number of products to be cooked.

A product management method by a computer, according to one aspect of the present disclosure including acquiring a discard time of a product based on a photographed image obtained by photographing the product displayed on a furniture and an expiration date of the product; predicting a sales quantity for each time zone based on a prediction model created using past sales quantity information of the product; estimating a number of products to be cooked for each time zone based on the discard time and the sales quantity of the product; and outputting the number of products to be cooked.

A recording medium according to one aspect of the present disclosure stores a program for causing a computer to execute processes of acquiring a discard time of a product based on a photographed image obtained by photographing the product displayed on a furniture and an expiration date of the product; predicting a sales quantity for each time zone based on a prediction model created using past sales quantity information of the product; estimating a number of products to be cooked for each time zone based on the discard time and the sales quantity of the product; and outputting the number of products to be cooked.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating a configuration example of a product management device according to the present disclosure;

FIG. 2 is a diagram illustrating a hardware configuration in which the product management device according to the present disclosure is implemented by a computer device and its peripheral devices;

FIG. 3 is a conceptual diagram illustrating an example of a case for displaying a product in the present disclosure;

FIG. 4 is a flowchart illustrating an operation of the product management device according to the present disclosure;

FIG. 5 is a block diagram illustrating a configuration example of a product management device according to the present disclosure; and

FIG. 6 is a flowchart illustrating an operation of the product management device according to the present disclosure.

### EXAMPLE EMBODIMENT

Hereinafter, an example embodiments of a product management device, a product management method, and a non-transitory recording medium recording a program according to the present disclosure will be described in detail with reference to the drawings. The present example embodiment does not limit the technology of the disclosure.

### First Example Embodiment

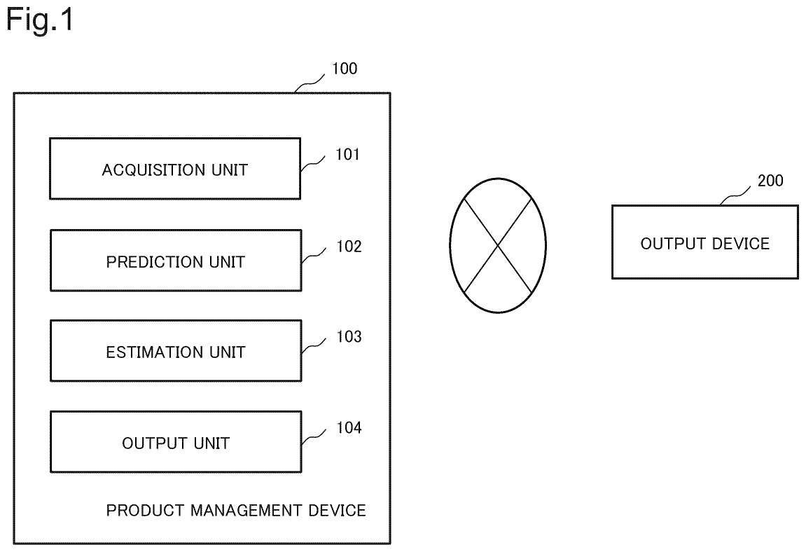

First, the present disclosure will be described in detail with reference to the drawings. FIG. 1 is a block diagram illustrating an example of a system configuration including a product management device 100 according to the present disclosure. As illustrated in FIG. 1, in a product management system, the product management device 100 is connected to an output device 200 via a network. The product management device 100 includes an acquisition unit 101, a prediction unit 102, an estimation unit 103, and an output unit 104.

The product management system is a system that manages cooked products displayed on furniture such as a hot showcase installed in the vicinity of a cash register of a convenience store or the like, particularly fried foods such as fried chicken, croquettes, and French fries.

The product management device 100 is a device that estimates the number of products that need to be cooked by an employee of a store. The output device 200 is a device that outputs an alert regarding the output of the number of products to be cooked and the disposal deadline, and includes, for example, a terminal device possessed by an employee.

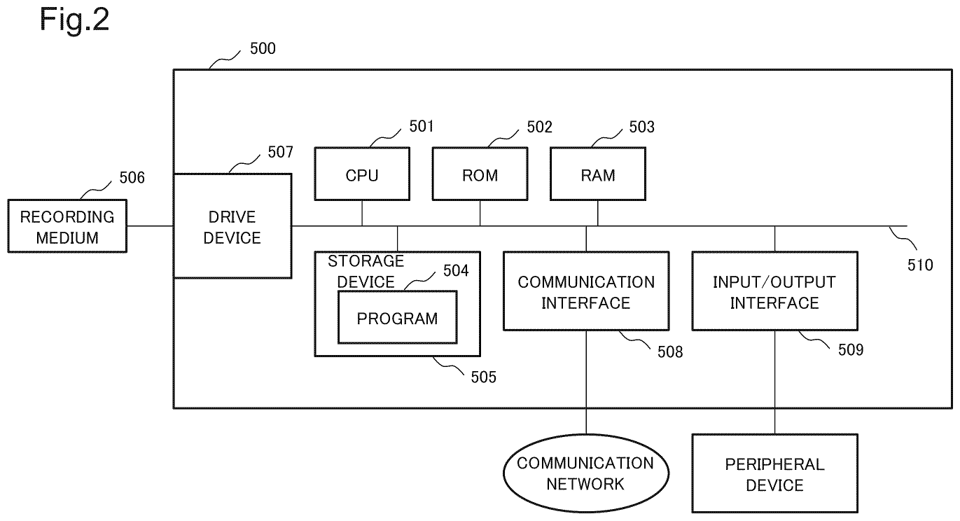

FIG. 2 is a diagram illustrating an example of a hardware configuration in which the product management device 100 in the present disclosure is achieved by a computer device 500 including a processor. As illustrated in FIG. 2, the product management device 100 includes a memory such as a central processing unit (CPU) 501, a read only memory (ROM) 502, and a random access memory (RAM) 503, a storage device 505 such as a hard disk that stores a program 504, a communication interface 508 for network connection, and an input/output interface 509 that inputs and outputs data. In the present disclosure, the product management device 100 is connected to each component via a bus 510. In addition, product management device 100 according to the present disclosure illustrated in FIG. 1 may be configured by cloud computing or the like.

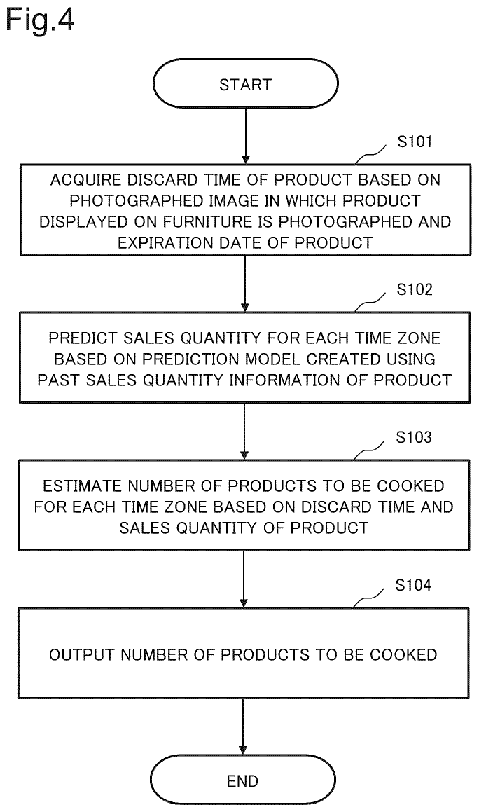

The CPU 501 operates the operating system to control the entire product management device 100 according to the present disclosure. In addition, the CPU 501, for example, reads a program and data from a recording medium 506 mounted on a drive device 507 or the like to a memory. In addition, the CPU 501 functions as the acquisition unit 101, the prediction unit 102, the estimation unit 103, the output unit 104, and a part thereof in the present disclosure, and executes a process or a command in a flowchart illustrated in FIG. 4, to be described later, in accordance with a program.

The recording medium 506 is, for example, an optical disk, a flexible disk, a magnetic optical disk, an external hard disk, a semiconductor memory, or the like. A semiconductor memory or the like that is a part of the recording medium is a non-volatile storage device, and records a program therein. Furthermore, the program may be downloaded from an external computer (not illustrated) connected to a communication network.

As described above, the product management device 100 illustrated in FIG. 1 is implemented by the computer hardware illustrated in FIG. 2. However, the implementation means of each unit included in the product management device 100 of FIG. 1 is not limited to the configuration described above. In addition, the product management device 100 may be achieved by one physically coupled device, or may have two or more physically separated devices connected by wire or wirelessly and achieved by a system including the plurality of devices.

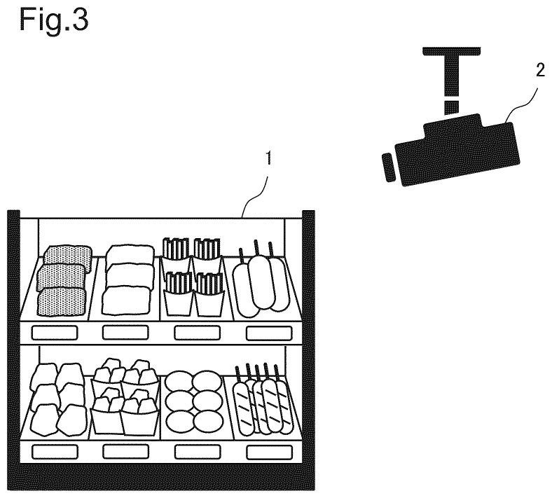

FIG. 3 is a conceptual diagram illustrating a configuration example of a hot snack case. The case 1 is, for example, furniture provided in a store of a retail store such as a convenience store and on which hot snacks cooked in the store are displayed. The inside of the case 1 is managed under the condition that the quality of the product can be maintained, and is managed to be able to be sold to the customer. Furthermore, in the store, a camera 2 is provided at a position where a display status of the furniture can be grasped. When the product management device 100 analyzes the photographed image photographed by the camera 2, it is possible to acquire that the product has been displayed, the displayed position, and the elapsed time from the display.

The acquisition unit 101 is a means for acquiring the discard time of the product based on the photographed image obtained by photographing the product displayed on the furniture and the expiration date of the product. The acquisition unit 101 analyzes the photographed image through a known method to specify each photographed product and the time at which the product is displayed. In addition, the acquisition unit 101 acquires the discard time of the product based on the time at which the product is displayed and the expiration date of the product. The expiration date of the product is, for example, an expiration date that is determined for each product and by which the product can be eaten while maintaining quality, and is stored in, for example, a storage device 505. The acquisition unit 101 outputs the acquired discard time to the estimation unit 103.

The acquisition unit 101 may tag the products through the camera 2 at the time point when the products are displayed on the furniture, and trace the elapsed time from the display of each product until the expiration date of the product elapses. For example, the acquisition unit 101 may trace the elapsed time for each product displayed at the same timing. In addition, in a case where rules are set on how to arrange cooked products in the furniture according to a store, the acquisition unit 101 may acquire the discard time based on a result of collation between the rules and the analysis result of the photographed image. An example of a rule may be to display a cooked product at a specific display place at a specific time.

The prediction unit 102 is a means for predicting the sales quantity for each time zone based on a prediction model created using the past sales quantity information of the product. The prediction model may be a model generated by machine learning in which the correlation between the sales quantity and the factor is learned. As the prediction model, for example, the model merely needs to have the past sales quantity set as the objective variable, and the objective variable expressed by a mathematical expression using the explanatory variable, and the content of the prediction model may be any content. As the explanatory variable, a parameter corresponding to a factor that affects the sales quantity is used. The prediction model may be a model generated for each time zone or each store.

The parameter is, for example, weather information (highest temperature, lowest temperature, weather) in the time zone of the prediction target, or information such as the number of customers.

The prediction unit 102 may predict the replacement timing of the ingredient to be used for cooking the product based on the estimated number of products to be cooked. Here, the ingredient is oil or the like used for cooking a product, and is intended to be one that deteriorates depending on the number of products to be cooked. For example, assume that there is a product that requires oil replacement every time 10 pieces are cooked. In this case, the prediction unit 102 predicts the timing to cook the tenth product as the oil replacement timing.

The estimation unit 103 is a means for estimating the number of products to be cooked for each time zone based on the discard time and the sales quantity of the product. As a method for estimating the number of products to be cooked, various known methods can be used. In the hot snack product, the product scheduled to be discarded and the product to be sold are reduced from the furniture in each time zone. That is, for example, the estimation unit 103 may set, as the number of products to be cooked, the total sales quantity in the same time zone as the number of products to be discarded in that time zone. The estimation unit 103 may estimate the number of products to be cooked for each time zone in which the customer class of the store changes, such as immediately after opening, at lunch time, in the evening, or immediately before closing, or may estimate the number of products to be cooked for each predetermined time (every two to four hours).

The estimation unit 103 may estimate the number of products to be cooked for each time zone in such a way as to include a time zone in which cooking is not performed. In a store, there is a possibility that cooking work cannot be performed in a time zone of a crowded time, a lunch time, a break time, and busy with other works. Therefore, the estimation unit 103 may predict the number of products to be cooked by increasing the number of products to be cooked in other time zones in such a way that cooking does not need to be performed in these time zones.

The output unit 104 is a means for outputting the predicted number of products to be cooked. The output unit 104 outputs the number of products to be cooked to one of the output devices 200 in the store. Furthermore, in a case where the prediction unit 102 predicts the replacement timing of the ingredient to be used for cooking the product, the output unit 104 may output the replacement timing of the ingredient.

FIG. 4 is a flowchart illustrating an outline of an operation of the product management device 100 in the present disclosure. The processes according to this flowchart may be executed based on a program control by the processor described above. The processes according to this flowchart is performed at any timing, for example, executed at a predetermined time in one day.

FIG. 4 is a flowchart illustrating an operation of the product management device 100 according to the present disclosure. The acquisition unit 101 acquires the discard time of the product based on the photographed image obtained by photographing the product displayed on the furniture and the expiration date of the product (step S101). Next, the prediction unit 102 predicts the sales quantity for each time zone based on the prediction model created using the past sales quantity information of the product (step S102). Next, the estimation unit 103 estimates the number of products to be cooked for each time zone based on the discard time and the sales quantity of the product (step S103). Lastly, the output unit 104 outputs the number of products to be cooked (step S104). Thus, the product management device 100 ends the product management process.

As described above, in the product management device 100 of the present disclosure, the estimation unit 103 estimates the number of products to be cooked for each time zone based on the discard time and the sales quantity of the product. Then, the output unit 104 outputs the number of products to be cooked. As a result, for example, the employee of the store can easily grasp the number of products to be cooked in the store.

### Modified Example of First Example Embodiment

Next, a modified example of the present disclosure will be described in detail with reference to the drawings. Hereinafter, description of contents overlapping with the above description will be omitted to the extent that the description of the present example embodiment is not unclear. Each modified example can be applied in combination.

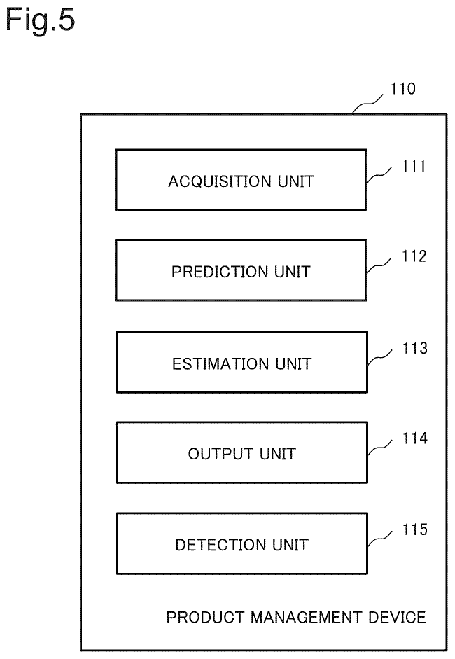

FIG. 5 is a block diagram illustrating a configuration example of a product management device 110 according to the modified example of the present disclosure. Referring to FIG. 5, the product management device 110 includes a detection unit 115 in addition to an acquisition unit 111, a prediction unit 112, an estimation unit 113, and an output unit 114. In the present modified example, a case where a product to be discarded remains on display on the furniture even after the discard time has passed is assumed.

The detection unit 115 is a means for detecting a product whose discard time has passed in the photographed image. For example, the detection unit 115 detects that a preset discard time has been reached while the product being traced through the camera is remained displayed. The detection unit 115 outputs the information to the output unit 114 at the detected timing. The detection unit 115 may output to the output unit 114 at a timing after a predetermined time has passed from the discard time. The detection unit 115 may detect a product whose discard time is a predetermined time before reaching the discard time soon.

The output unit 114 outputs an alert to notify that the discard time has passed. The output unit 114 may cause different alerts to be output according to a time passed from the discard time. The output unit 114 may change the strength of the alert according to the time passed after the discard time. The output unit 104 may notify a terminal of the head office that controls each store of an alert when a predetermined time or more (e.g., 6 hours or more) has passed.

### Second Modified Example of First Example Embodiment

Next, another modified example of the present disclosure will be described. Hereinafter, description of contents overlapping with the above description will be omitted to the extent that the description of the present example embodiment is not unclear. In the present modified example, a case where an alert is output when the number of products displayed on the furniture is less than the predicted number of products.

The detection unit 115 detects that the product displayed on the furniture is insufficient as compared with the predicted sales quantity. That is, for example, the detection unit 115 counts the number of products through the camera, and outputs the information to the output unit 114 at a timing the number of products becomes less than the sales quantity predicted by the prediction unit 112. The detection unit 115 may output to the output unit 114 at a timing the number of displayed products is reduced by equal to or more than a predetermined number from the predicted sales quantity.

The output unit 114 outputs an alert to notify that the displayed product is insufficient. The output unit 114 may cause different alerts to be output according to the insufficient number of products.

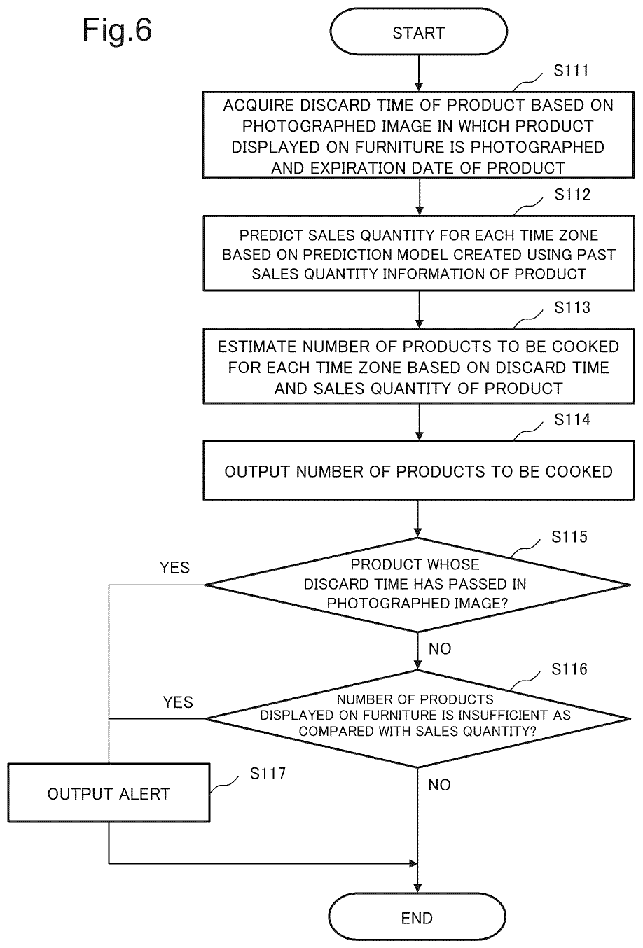

FIG. 6 is a flowchart illustrating an operation of the product management device 110 according to the present disclosure. In this flowchart, the flow of S111 to S114 is similar to that of S101 to S104 in FIG. 4. That is, the acquisition unit 111 acquires the discard time of the product based on the photographed image obtained by photographing the product displayed on the furniture and the expiration date of the product (step S111). Next, the prediction unit 112 predicts the sales quantity for each time zone based on the prediction model created using the past sales quantity information of the product (step S112). Next, the estimation unit 113 estimates the number of products to be cooked for each time zone based on the discard time and the sales quantity of the product (step S113). Then, the output unit 114 outputs the number of products to be cooked (step S114). Next, in a case where the detection unit 115 detects a product whose discard time has passed in the photographed image (S115; YES), or a case where the detection unit detects that the number of products displayed on furniture is insufficient as compared with the predicted sales quantity (step S116; YES), the output unit 114 outputs an alert (step S117). On the other hand, when the product whose discard time has passed is not detected in the photographed image by the detection unit 115 (S115; NO) and when it is not detected that the product displayed on the furniture is insufficient as compared with the predicted sales quantity (step S116; NO), the flow is ended. Thus, the product management device 110 ends the product management process.

As described above, in the product management device 110 according to the present disclosure, when the detection unit 115 detects a product whose discard time has passed in the photographed image, or when the detection unit detects that a product displayed on the furniture is insufficient as compared with the predicted sales quantity, the output unit 114 outputs an alert. As a result, it is possible to notify an employee of the store that the product needs to be discarded or replenished.

Hot snack products need to be cooked in advance and displayed by the amount to be sold by an employee of the store. However, it is difficult for an employee of the store to cook only the amount to be sold in consideration of the disposal deadline.

According to the present disclosure, a product management device that can easily grasp the number of products to be cooked in a store can be provided.

Although the present disclosure has been described with reference to the example embodiments, the present disclosure is not limited to the example embodiments described above.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

The configuration and details of the present disclosure may include example embodiments to which various changes that can be grasped by those of ordinary skill in the art within the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, in a modified example of the present disclosure, the detection unit 115 may detect that the replacement timing of the ingredient has passed, and the output unit 114 may output an alert indicating that the replacement timing of the ingredient has passed. In addition, although the plurality of operations are described in order in the form of a flowchart, the order of description does not limit the order of executing the plurality of operations. Therefore, when each example embodiment is implemented, the order of the plurality of operations can be changed within a range that does not interfere with the content.

Further, it is noted that the inventor's intent is to retain all equivalents of the claimed invention even if the claims are amended during prosecution.

Some or all of the above example embodiments may be described as the following supplementary notes, but are not limited to the following.

### SUPPLEMENTARY NOTE

### (Supplementary Note 1)

A product management device including:
an acquisition means for acquiring a discard time of a product based on a photographed image obtained by photographing the product displayed on a furniture and an expiration date of the product;
a prediction means for predicting a sales quantity for each time zone based on a prediction model created using past sales quantity information of the product;
an estimation means for estimating a number of products to be cooked for each time zone based on the discard time and the sales quantity of the product; and
an output means for outputting the number of products to be cooked.

### (Supplementary Note 2)

The product management device according to supplementary note 1, wherein the acquisition means acquires the discard time of the product based on an elapsed time from a time when the product is displayed.

### (Supplementary Note 3)

The product management device according to supplementary note 1, wherein the estimation means estimates the number of products to be cooked for each time zone to include a time zone in which cooking is not performed.

### (Supplementary Note 4)

The product management device according to supplementary note 1, wherein the prediction means predicts the sales quantity for each time zone by using a prediction formula represented by a parameter that affects the sales quantity.

### (Supplementary Note 5)

The product management device according to supplementary note 4, wherein the prediction means predicts the sales quantity for each time zone by using a prediction formula represented by a parameter different for each time zone.

### (Supplementary Note 6)

The product management device according to supplementary note 1, wherein
the prediction means further predicts a replacement timing of an ingredient to be used for cooking the product based on the estimated number of products to be cooked, and
the output means outputs the replacement timing of the ingredient.

### (Supplementary Note 7)

The product management device according to supplementary note 6, further including a detection means for detecting a product whose discard time has passed in the photographed image, wherein
the output means further outputs an alert to notify that the discard time has passed.

### (Supplementary Note 8)

The product management device according to supplementary note 7, wherein
the detection means further detects insufficiency of a product displayed on the furniture as compared with the sales quantity, and
the output means further outputs an alert to notify that the displayed product is insufficient.

### (Supplementary Note 9)

A product management method executed by a computer, the method including:
acquiring a discard time of a product based on a photographed image obtained by photographing the product displayed on a furniture and an expiration date of the product;
predicting a sales quantity for each time zone based on a prediction model created using past sales quantity information of the product;
estimating a number of products to be cooked for each time zone based on the discard time and the sales quantity of the product; and
outputting the number of products to be cooked.

### (Supplementary Note 10)

A program for causing a computer to execute processes of:
acquiring a discard time of a product based on a photographed image obtained by photographing the product displayed on a furniture and an expiration date of the product;
predicting a sales quantity for each time zone based on a prediction model created using past sales quantity information of the product;
estimating a number of products to be cooked for each time zone based on the discard time and the sales quantity of the product; and
outputting the number of products to be cooked.

Some or all of the configurations described in the supplementary notes 2 to 8 dependent on the supplementary note 1 described above can also be dependent on the supplementary notes 9 and 10 by the same dependency relationship as the supplementary notes 2 to 8. Not limited to the supplementary notes 1, 9, and 10, some or all of the configurations described as the supplementary notes can be similarly dependent on various hardware, software, various recording devices for recording software or systems without departing from the scope of the above-described example embodiments.

### REFERENCE SIGNS LIST

100, 110 product management device
101, 111 acquisition unit
102, 112 prediction unit
103, 113 estimation unit
104, 114 output unit
115 detection unit
500 computer device
501 CPU
502 ROM
503 RAM
504 program
505 storage device
506 recording medium
507 drive device
508 communication interface
509 input/output interface
510 bus

1. A product management device comprising:
a memory storing instructions; and
one or more processors configured to execute the instructions to:
acquire a discard time of a product based on a photographed image obtained by photographing the product displayed on a furniture and an expiration date of the product;
predict a sales quantity for each time zone based on a prediction model created using past sales quantity information of the product;
estimate a number of products to be cooked for each time zone based on the discard time and the sales quantity of the product; and
output the number of products to be cooked.

2. The product management device according to claim 1, wherein
the one or more processors are further configured to execute the instructions to
acquire the discard time of the product based on an elapsed time from a time when the product is displayed.

3. The product management device according to claim 1, wherein
the one or more processors are further configured to execute the instructions to
estimate the number of products to be cooked for each time zone to include a time zone in which cooking is not performed.

4. The product management device according to claim 1, wherein
the one or more processors are further configured to execute the instructions to
predict the sales quantity for each time zone by using a prediction formula represented by a parameter that affects the sales quantity.

5. The product management device according to claim 4, wherein
the one or more processors are further configured to execute the instructions to
predict the sales quantity for each time zone by using a prediction formula represented by a parameter different for each time zone.

6. The product management device according to claim 1, wherein
the one or more processors are further configured to execute the instructions to:
further predict a replacement timing of an ingredient to be used for cooking the product based on the estimated number of products to be cooked; and
output the replacement timing of the ingredient.

7. The product management device according to claim 6, wherein
the one or more processors are further configured to execute the instructions to:
further detect a product whose discard time has passed in the photographed image; and
further output an alert to notify that the discard time has passed.

8. The product management device according to claim 7, wherein
the one or more processors are further configured to execute the instructions to:
further detect insufficiency of a product displayed on the furniture as compared with the sales quantity, and
further output an alert to notify that the displayed product is insufficient.

9. A product management method by a computer, the information processing method comprising:
acquiring a discard time of a product based on a photographed image obtained by photographing the product displayed on a furniture and an expiration date of the product;
predicting a sales quantity for each time zone based on a prediction model created using past sales quantity information of the product;
estimating a number of products to be cooked for each time zone based on the discard time and the sales quantity of the product; and
outputting the number of products to be cooked.

10. A non-transitory computer-readable recording medium that records a program for causing a computer to execute:
acquiring a discard time of a product based on a photographed image obtained by photographing the product displayed on a furniture and an expiration date of the product;
predicting a sales quantity for each time zone based on a prediction model created using past sales quantity information of the product;
estimating a number of products to be cooked for each time zone based on the discard time and the sales quantity of the product; and
outputting the number of products to be cooked.
